(19) United States
(12) Patent Application Publication
(10) Pub. No.: US 2006/0185496 A1
(43) Pub. Date: Aug. 24, 2006

(54) Conga stand

(75) Inventors: Reinhard Wening, Dietenhofen (DE); Wolfgang Payerl, Munchsteinach (DE)

Correspondence Address: BROWDY AND NEIMARK, P.L.L.C.;624 NINTH STREET, NW, SUITE 300, WASHINGTON, DC, 20001-5303, US

(73) Assignee: Roland Meinl Musikinstrumente GmbH & Co. KG, Neustadt/Aisch (DE)

(21) Appl. No.: 11/321,052

(22) Filed: Dec. 30, 2005

(30) Foreign Application Priority Data
Dec. 30, 2004 (DE) 10 2004 063 371.1

(51) Int. Cl. G10D 13/02

(52) U.S. Cl. 84/421

(57) ABSTRACT

In a conga stand comprising a holding ring for insertion of the conga or the like, also holding projections resting laterally against the conga, as well as legs connected to the holding ring, each leg being implemented height-adjustable in such a way that it consists of at least two sections that are curved or angled about their longitudinal direction so that they are displaceable relative to each other in a telescopic manner, wherein each section has a plurality of bores in the longitudinal direction, and wherein locking screws are provided that extend through two bores in each case while setting a specified length, wherein the lower bore in each case is implemented as a threaded bore, or the screws extend through the bores in such a way that a lock nut can be placed on the inner end, provision is made for the bores of at least one section to be connected by a longitudinal slot, the width of which corresponds approximately to the diameter of the threaded section of the screws.

### FIELD OF THE INVENTION

The invention is directed to a conga stand comprising a holding ring for insertion of the conga or the like, also holding projections testing laterally against the conga, as well as legs connected to the holding ring, each leg being implemented height adjustable in such a way that it consists of at least two sections that are curved or angled about their longitudinal direction so that they are displaceable relative to each other in a telescopic manner, wherein each section has a plurality of bores in the longitudinal direction, and wherein locking screws are provided that extend through two bores in each case while setting a specified length, wherein the lower bore in each case is implemented as a threaded bore, or the screws extend through the bores in such a way that a lock nut can be placed on the inner end.

### BACKGROUND OF THE INVENTION

A conga stand of this type is known from DE 295 00 540 U1 and has proven extraordinarily useful in practice.

### SUMMARY OF THE INVENTION

Proceeding from a known conga stand of this type, the invention is based on the object of further simplifying the height adjustment and/or permitting the implementation of relatively tall legs while providing for an optimum stability.

This object is met according to the invention in such a way that the bores of at least one section are connected by a longitudinal slot, the width of which corresponds approximately to the diameter of the threaded section of the screws.

The slots provided according to the invention make it possible to only slightly loosen the locking screws for the height adjustment, without completely unscrewing them.

Provision may advantageously be made for the bores of the section that is located on top, specifically the lower section, to have on its outside a widened area to accommodate a screw head in a recessed manner.

The sections of the legs are advantageously implemented curved or approximately V-shaped or U-shaped, thereby providing a formfitting fit and, hence, a high degree of stability.

In a further development of the invention or as a separate variant, provision may be made for a first upper section of each leg and a second lower section of each leg to be joined by means of a connecting element having bores and a corresponding cross section and locking screws.

In this manner it is possible to produce particularly tall legs or also to lengthen existing conga stands as desired.

To attain a particularly good degree of stability, provision is advantageously made for at least two screws to be provided in each case for fastening the connecting section to the upper section and to the lower section.

The invention is also directed to a lengthening kit comprising the connecting sections of the above-described type.

The invention will be described below based on a preferred example embodiment in conjunction with the drawing.

### BRIEF DESCRIPTION OF THE DRAWING

FIG. 1 shows a perspective view of a conga stand according to the prior art,

FIG. 2 shows a top view of a portion of a leg with a lengthening section, and

FIG. 3 shows a section along the line III-III in FIG. 2.

### DESCRIPTION OF THE PREFERRED EMBODIMENT

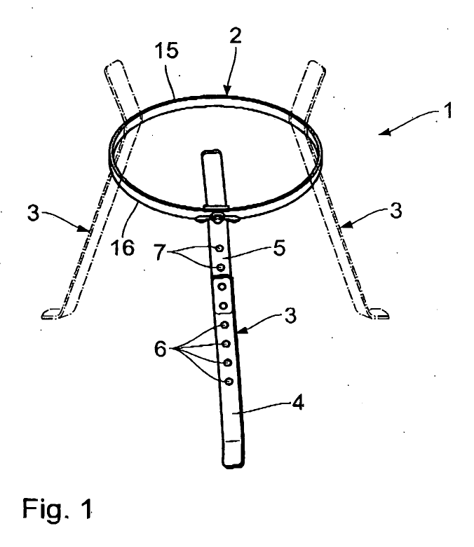

A conga stand shown in FIG. 1, as it is known from DE 295 00 540 U1, comprises a holding ring 2, on which three legs 3 are mounted.

Each leg 3 comprises a lower section 4 and an upper section 5, which, as is apparent from FIG. 3, are curved perpendicular to their longitudinal direction, while having the same radius of curvature, so that they can be fitted together while overlapping telescopingly. The upper and the lower section 5 and 4 have a series of equidistant bores 6 and 7, said bores 7 of the upper section 5, which is the section located underneath when in use, having an internal thread.

By telescoping displacement of the sections 4 and 5 relative to one another, the height of the leg 3 can be adjusted and at least two bores 6 and 7 can be moved into congruence with each other, so that a position that has been adjusted in this manner can be secured by means of two screws 11. The insertion of the screws 11 and curvature of the sections 4 and 5 provide for a stable, non-warping construction.

A certain shortcoming of this previously known conga stand lies in that, for purposes of height readjustment or height adjustment of the legs 3, the screws must in each case be completely unscrewed from the threaded bore or from a nut optionally placed thereon, and must be fastened manually relative to each other when adjusting the individual sections 4, 5.

In accordance with the invention, at least one section, in the example embodiment an additional connecting section 8, now has provided on it a slot 9 that connects the bores 6′, the width of said slot 9 corresponding to the diameter of the threaded section 12 of the screws 11. If the screws 11 are accordingly loosened slightly, the individual sections 6 and 7 and 8 can be displaced relative to one another without losing the lateral alignment. Once the desired height setting has been attained, the screws are tightened.

Providing an intermediate section 8 in addition to an upper section 5 and lower section 4 of the legs 3 makes it possible to design the legs 3 relatively long. Additional intermediate sections 8 of this type can also be supplied later as an add-on kit for lengthening the legs 3 of a generic known conga stand 1.

A particularly good stability is achieved in such a way that the connection between the intermediate section 8 and the upper section 5 and lower section 4 is implemented in each case by means of two screws 11 that are positioned above one another.

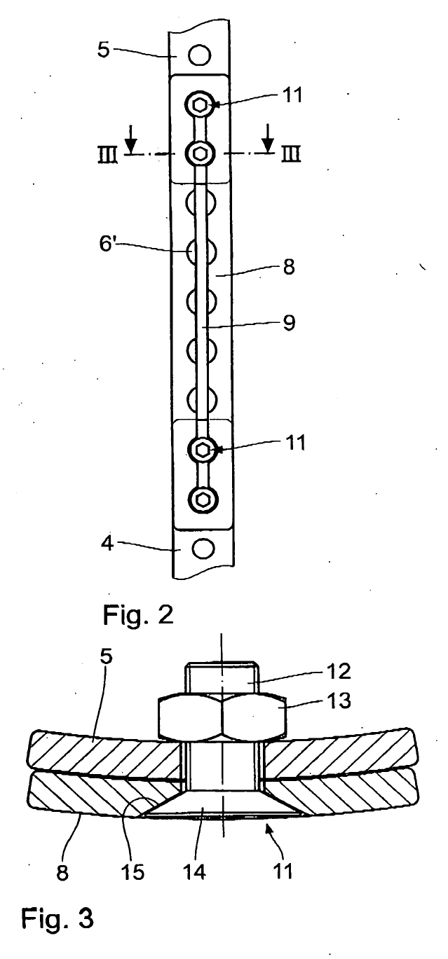

Presented in FIG. 3 is a section along the line III-III in FIG. 2, wherein, in this example embodiment, provision is made not for a threaded bore, but for a lock nut 13 that is placed on the threaded section 12.

The leg sections 5, 8, are curved semi-circular and rest against one another with corresponding curvatures. The width of the slot 9 corresponds, as previously mentioned, to the diameter of the threaded section 12 of the screws 11. The screws additionally have a conical head 14 that is accommodated recessed in a widened section 15 of the leg section 8.

What is claimed is:

1. A conga stand (1) comprising a holding ring (2) for insertion of the conga or the like, also holding projections resting laterally against the conga, as well as legs (3) connected to the holding ring (2), each leg (3) being implemented height-adjustable in such a way that it consists of at least two sections that are curved or angled about their longitudinal direction so that they are displaceable relative to each other in a telescopic manner; wherein each section has a plurality of bores in the longitudinal direction, and wherein locking screws are provided that extend through two bores in each case while setting a specified length, wherein the lower bore in each case is implemented as a threaded bore, or the screws extend through the bores in such a way that a lock nut can be placed on the inner end, wherein the bores (6, 7) of at least one section (4, 5) are connected by a longitudinal slot (9), the width of which corresponds approximately to the diameter of the threaded section (12) of the screws (11).

2. A conga stand according to claim 1, wherein the bores (6) of the section located on top, specifically the lower section (4), incorporate on the outside a widened area (15) for recessed accommodation of a screw head (14).

3. A conga stand according to claim 1, wherein the sections (4, 5) are implemented curved or approximately V-shaped or U-shaped in cross section.

4. A conga stand, particularly according to claim 1, wherein a first upper section (5) of each leg (3) and a second lower section (4) of each leg (3) is joined via a connecting section (8) having bores (6′) and a corresponding cross section and locking screws (11).

5. A conga stand according to claim 4, wherein, to fasten the connecting section (8) on the upper section and on the lower section (5 and 4), at least two screws (11) are provided in each case.

6. A lengthening kit, particularly for a conga stand according to claim 1, comprising at least three intermediate leg sections (8) having bores (6 and 7) corresponding to the upper leg section (5) and lower leg section (4) and having a cross-section configuration corresponding to these leg sections (4 and 5).
